(19) United States
(12) Patent Application Publication
(10) Pub. No.: US 2012/0066019 A1
(43) Pub. Date: Mar. 15, 2012

(54) CONSTRUCTION CONTROL SYSTEM

(75) Inventors: Foster D. HINSHAW, Cambridge, MA (US); William J. Fosnight, Saratoga Springs, NY (US)

(73) Assignee: Dunmow Systems Corporation, Cambridge, MA (US)

(21) Appl. No.: 13/178,344

(22) Filed: Jul. 7, 2011

Related U.S. Application Data
(60) Provisional application No. 61/362,145, filed on Jul. 7, 2010.

(51) Int. Cl. G06Q 10/06

(52) U.S. Cl. 705/7.23

(57) ABSTRACT

A building material and workflow control system adapted to manage workflow associated with a building of a construction project at a job site. The building material and workflow control system has a server having a processor and a database. The processor is programmed to identify a construction sequence of the construction project. The processor is further programmed to identify kits of assets and materials needed to execute steps of the construction sequence. The processor is further programmed to identify and implement assembly features on the materials associated with use of the assets needed to execute steps of the construction sequence. The processor is further programmed to provide and stage the kits of assets and materials from a source to the jobsite utilizing real time dynamic knowledge of an erection state of the building at the job site.

### RELATED APPLICATIONS

This application claims the benefit of and priority from U.S. Provisional Patent Application Ser. No. 61/362,145 Entitled “CONSTRUCTION CONTROL SYSTEM” and filed on Jul. 7, 2010 which is hereby incorporated by reference herein in its entirety.

### BACKGROUND

1. Field

The disclosed embodiments relate to a construction control system and, more particularly, to a commercial or residential homebuilding material and workflow control system.

2. Brief Description of Earlier Developments

Residential or commercial construction projects may be managed without the use of any significant job control software where the projects are managed with spreadsheets, hard copy purchase orders and schedules that often are unpredictable and late. Such an approach to construction is not desirable in operational conditions as it introduces cost overruns, schedule delays and overall customer dissatisfaction with the construction experience. Still, advances have been made where home or commercial construction projects that are managed without the use of any significant job control software where the projects are managed with computerized prefab architect design systems where the system produces construction documents, for example, layouts and materials lists. A problem arises in the use of such systems where variations in construction inevitably occur after the initial design package is completed and the variations are not accommodated in the construction documents or planning resulting once again in cost overruns, schedule delays and overall customer dissatisfaction with the construction experience. Accordingly, there is a desire to have a system which accommodates design and construction variations before and during the construction process.

### BRIEF DESCRIPTION OF THE DRAWINGS

The foregoing aspects and other features of the exemplary embodiments are explained in the following description, taken in connection with the accompanying drawings, wherein:

FIG. 1 is a functional diagram of a construction control system;

FIG. 2A is a functional diagram of a server and modules;

FIG. 2B is a functional diagram of a construction control system;

FIG. 2C is a functional diagram of a job site and support infrastructure;

FIG. 2D is a functional diagram of a tracking system;

FIG. 3 is a functional diagram of a server and repository;

FIG. 4 is a diagram of server components;

FIG. 5 is a diagram of server modules;

FIG. 6 is a diagram of server J2EE modules;

FIG. 7 is an activity diagram of content repository management;

FIG. 8 is a functional diagram of a mill control module;

FIG. 9 is a functional diagram of a job control module;

FIG. 10 is a functional diagram of a construction site control module;

FIG. 11 is a BOM activity interaction diagram;

FIG. 12 is a job controller activity interaction diagram;

FIG. 13 is a diagram of a use case;

FIG. 14 is a diagram of a use case;

FIG. 15 is a diagram of a use case;

FIG. 16 is a diagram of a use case;

FIG. 17 is a diagram of a use case; and

FIG. 18 is a diagram showing stick controller information.

### DETAILED DESCRIPTION OF THE EXEMPLARY EMBODIMENT(S)

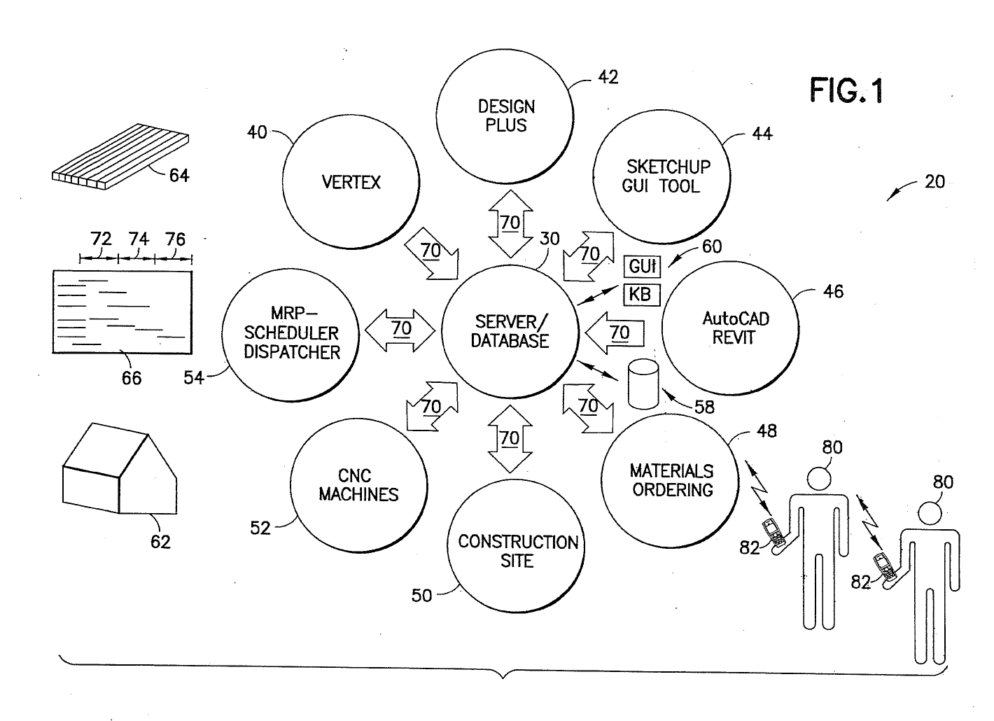

Referring to FIG. 1, there is shown, a diagram of construction control system 20 capable of managing material and workflow for residential or other construction and incorporating features in accordance with an exemplary embodiment. Although the present invention will be described with reference to the embodiments shown in the drawings, it should be understood that the present invention may be embodied in many alternate forms of embodiments. In addition, any suitable size, shape or type of elements or materials could be used. In the embodiment shown, system 20 may comprise Residential Homebuilding Material Control System (RHMCS) 20 that may maintain all item and location data real time for design, millwork and construction phases (real-time as-built). System 20 enables efficient material ordering, scheduling, dispatch, job execution, material management, control of automation, placement of materials, human safety (location of people) pace-setting, and compliance to codes green initiatives (e.g. Energy Star, LEED, FSC). Feedback into system 20 may include data transmitted from automation 52 which may be on or off site, for example, status of task or position of automation and material from local position feedback system(s) as well as data transmitted from humans 80, for example, via smart phone interface 82 with location information. System 20 enables streamed (lean manufacturing) as opposed to what is currently batch processing. System 20 may include full visualization capability of shop floor or construction site for remote monitoring. In alternate embodiments, any suitable visualization associated with the project 62 may be provided. System 20 may perform look-ahead simulation to optimize dispatching, for example, of materials, labor or assets such as automation or capital equipment. In the embodiment shown, system 20 is able to update some or all data as required and adjust some or all elements in case of variances, exceptions or changes in feedback. By way of example, if a sill plate is measured to be ¼″ off, database 20 may dynamically alter the design, the pull-list, material list, fastener schedule, schedule, dispatch, and machine instructions or otherwise where are all updated in real time and substantially immediately. As such, homebuyer or builder modifications may be accommodated real time while minimizing cost and schedule impact. Server 20 is provided with an end-to-end interface and protocol (common language) to further facilitate efficient communications and interaction between database 20 and modules 40, 42, 44, 46, 48, 50, 52, 54.

Construction control system 20 and, more particularly, residential homebuilding material and workflow control system 20 is illustrated as generally having server 30 having access to a database. Server 30 communicates with Vertex CAD module 42, Design Plus module 42, Sketchup GUI Tool 44, AutoCAD REVIT module 46, Materials Ordering module 48, Construction or Job Site 50, CNC machine(s) 52 and MRP Scheduler Dispatcher 54, User Interface 60 and Programmable Memory Storage 58. System 20 provides a construction control system, such as a residential homebuilding material and workflow control system to manage items and workflow associated with a construction project at job site 50. Database 30 has temporal data 70 associated with real time dynamic knowledge of the items, such as lumber 64 and workflow such as work and material schedule 66. Temporal data 70 may include a dynamic erection state during different phases 72, 74, 76 of erection of the construction project. The erection state is obtained utilizing bi-directional communication 70 between database 30 and a status of different process steps at job site 50. In the embodiment shown, construction control system 20 has a database 30 having real time dynamic knowledge of the items. For example, the real time dynamic knowledge of items may include a state of construction of the items and a location of the items. In alternate the real time dynamic knowledge may include any attribute associated with the construction project. By way of further example, the real time dynamic knowledge of the items may include information and data in the database identifying at least one predetermined characteristic of an item based on both a design condition and a variance from the design condition where at least one predetermined characteristic of an item includes information related to a variance relative to the design condition. In the embodiment shown, system 20 provides end to end integration of all aspects of the construction project 62, for example, design, millwork, construction and materials processing or otherwise. In addition, building code and energy standard compliance may drive variances in the design that database 30 may adapt to in real time. For example, system 20 is provided with intelligent design module 42 programmed, for example, with a rules based algorithm to automatically incorporate local rules, knowledge, and content for design. Module 42 Automatically applies local rules to design to conform with regulations, code and local preferences. Database 30 dynamically generates materials matched to data and content from the design as changes or variances occur. Database 30 further provides interfaces, mountings, processes for sourcing and fabrication, for example, fabrication sequencing may be identified. Database 30 further provides sequence for delivery and erection, special tooling, coordinates, trades such as required for material, labor and capital asset management. Database 20 is updated to identify state and location, through different process steps (database reflects real time configuration and state). A state module may be provided to generate visual model(s) which may have any form, for example could be 2-D or 3-D representation of the design, may identify material items with data and content specific to item and state, and can identify critical data and critical points. Database 30 identifies a sequence for all stations, both machine controlled and human operated. For example, a human sequence may be data delivered to portable device listing data and sequence. Certification of all materials may be conducted in fabrication and/or on site. Complete on site certification of all materials may be enabled by a location module, for example, where the location module eliminates “tape measure” on site. Positioning data may be captured by any suitable position system including gps, laser, bar code, OCR or any suitable scanner where the system may create a map space with partial or full content as required. For example, the position system may identify on site locations of “landmarks” and fiducials in map space where internal “GPS” systems confirm position and variances. In alternate embodiments, inertial or any other suitable position system, such as laser based systems may be provided. Further, in alternate embodiments, parallel positioning sensors may be used to “filter” spurious positioning signals. Map space may be dynamically updated during erection process and fed back to database 30 as a variation from design. As such, database 30 provides a deterministic approach and logic and may employ parameter limitations and constraints to refine and determine position from measured. Database 30 is updated continuously with status and state data where state model is updated as well. As such, the design model reflects and embodies the real time configuration and state of project 62 during the erection process. System 20 brings full sequencing to home construction where knowledge of all items and their locations, including parts, assets, labor, systems including services are updated in real time. System 20 tracks and knows the status of each item, step and placement both when, were and otherwise. System 20 further provides full visualization from display 60 allowing for active feedback with actual placement for the next layer and full audit. Items are provided with full marking and identification, for example via indicia identified content, sequence, placement (ink, indents, RFID tags) or otherwise. System 20 may utilize an end-to-end interface and protocol (common language) for communication and execution efficiency. System 20 provides for streaming manufacturing providing material and work flow control for what is typically a batch process including control of assets such as built in & delivered special tooling, scaffolds, landmarks, lift points laser mounts or otherwise. System 20 provides aid, at least in part, to trades, for example pre drilled holes, or pre wired or pre kit rough framing and supports portions of all trades involved in the procurement and construction of project 62. Database 30 maintains real time dynamic knowledge of all items, for example, state and location where database 30 is automatically generated after application of intelligent design by module 42. In addition, real time database 30 is provided to dispatch and sequence materials, labor and workflow such that where variances occur, adjustments are made in a real time dynamic fashion within the temporal database minimizing delays and cost impact. As database 30 collects data, for example, measurements from the construction site, mill and otherwise as the materials are being fabricated on a as needed basis, real time updates may be accomplished when variances, for example, foundation actual size or level, affect the remaining construction where certification of all materials and tasks are provided prior to integration such that construction proceeds seamlessly where, for example, no tape measure are needed on site. Database 30 further provides validation during the erection process as status and any variances are fed back real time and accommodated. Server 20 further integrates automation associated with the construction project including CNC fabrication of component kits, such as lumber kits, and by way of further example, including automated framing, wiring, insulating, plumbing or any suitable automation as may be applied to construction project 62. As such, in the embodiment shown, building material and workflow control system 20 manages workflow associated with a building of a construction project 62 at a job site where building material and workflow control system 20 has server 30 having a processor and a database. The processor may be programmed to identify a construction sequence 66 of the construction project 62. The processor may be further programmed to identify kits of assets and materials 64 needed to execute steps of the construction sequence 66. The assets 64 may comprise human resources and construction equipment. Alternately, assets 64 may comprise human assisted construction automation. The materials 64 may comprise lumber and fasteners. Alternately, materials 64 may comprise prefabricated panels. The kits of assets and materials 64 may be identified to ensure construction code compliance. Further, the kits of assets and materials 64 may be updated to accommodate a detected variance from a design condition. The processor may be further programmed to identify and implement assembly features on the materials 64 associated with use of the assets needed to execute steps of the construction sequence 66. The processor may be further programmed to provide and stage the kits of assets and materials from a source to the jobsite utilizing real time dynamic knowledge of an erection state of the building at the job site. The real time dynamic knowledge of the erection state of the building at the job site may arise from communication between a position sensing device on the assets or materials 64 and the server 30. Alternately, the real time dynamic knowledge of the erection state of the building at the job site may arise from communication between human resources 80 at the job site and the server 30. In the embodiment shown, server 30 may update the erection state of the building at the job site based on real time feedback from the assets 64, 80.

In the embodiment shown, control system 20 maintains database 30 that may act as a repository for “rich data” where maintaining such rich data enables the interconnectivity and updatability for the various components that may interface with database 30 or may function within system 20 where the components may be third-party tools or modules, in-house developed tools or modules, or otherwise function as systems or components of the overall system 20. By way of example, Vertex system 40, AutoCAD REVIT system 46 and MRP Scheduler 54 may communicate and interact in either a one way or two way manner. An exemplary one way process may have steps where a house is designed with REVIT 46 and a .DWG file is created and downloaded into database 30. The DWG file may then be uploaded into Vertex 40 and a detailed design may then be made in Vertex 40. An XML file may then be downloaded from Vertex to the CNC Machines 52 or otherwise for fabrication. Without the capabilities of server/database 30 and in the exemplary one way process, once the file is modified by Vertex 40, a user would be unable to load the file back into REVIT 46 for changes without losing the detailed design data, or Vertex rich data from Vertex system 40. In the exemplary process, REVIT 46 or any other system or subsystem may not recognize or have methods to handle the added data from Vertex 40 or any other system or subsystem. By way of further example, if a downstream process such as the CNC Machine 52 or MRP Scheduler 54 were to add data or annotations, the file could not be loaded back to Vertex without losing the added details. Accordingly and without the features of server/database 30 the flow of data may be limited to being a one way flow from module to module, for example, from Revit 46 to Vertex 40 to CNC 52 or otherwise. With the disclosed server/database 30, two way data flow is enabled. Here, central database 30 maintains fields of data which specific tools generate or require, as rich data. By way of example, Vertex 40 may add detailed stick information which other sub systems, for example, REVIT 46 may not be capable of using, for example, either because Revit 46 does not support the data, because it would overwhelm the system or otherwise. By way of further example, rich data may be the sequencing information which MPR scheduler 54 may add where neither REVIT 46 or Vertex 40 would be able to store this information or to keep the sequencing information with the corresponding items to be sequenced. However, with the use of server/database 30, two way communication may be enabled, for example, where a design may be reloaded into REVIT 46 after having been through the detail design process of Vertex 40. With an exemplary two way process with server/database 30, the data may be downloaded from REVIT 46 into the central database 30 which may include all information from REVIT 46, for example, not only that information that Vertex requires but all information that Revit 46 may provide. Database 30 may then selectively upload those fields of data to Vertex 40, for example, those which Vertex 40 requires for its operation or those that database 30 selectively designates, where server/database 30 may tag the data. A user may then conduct detailed design in Vertex system 40 where the data from Vertex 40 may then be downloaded back to database 30. Database 30 in the download process may then merge the data back with the REVIT-specific data, for example the REVIT 46 rich data which was not tagged for use with Vertex 40 prior to detailed design. Here, the rich data from each subsystem of system 20 may be maintained and updated within and by server/database 30 such that the data within database 30 is updated on a real time basis and where the updated data for each subsystem may be ported between systems and subsystems in a real time and two way fashion. Here, construction control system 30 interfaces between first and second construction modules 40, 46 or otherwise and manages data associated with a construction project. Server 30 extracts data relevant to the second construction module 40 data associated with the first construction module 46 where the second construction module 40 is adapted to modify the extracted data as modified second construction module data, and where server 30 is adapted to extract a portion of the modified second construction module data relevant to first construction module 46 and update the first construction module data with the portion of the modified second construction module data relevant to the first construction module 46. By way of further example, if a house or other structure is designed using REVIT 46; detailed using Vertex 40; and sequenced using MRP Scheduler 54, with a one way processes, data sent back to REVIT 46 would lose sequencing information from MRP system 54 and the detailed design from Vertex 40. With the use of server 30, such data is not lost and two way communication is available among disparate systems without loss of data. By way of example, a house or other structure may be designed with REVIT 46 and a .DWG file created and downloaded to central database 30 which has fields and a catalog to save REVIT-specific information, or REVIT rich data, such as information that is not necessary for Vertex 40 or other downstream processes. The fields that Vertex 40 requires may be extracted and uploaded into Vertex 40 and a detailed design may be made in Vertex 40. An .XML file may then be downloaded from Vertex to central database 30 and as it is loaded, or subsequently or otherwise, the data may be merged with the previously stored rich data fields from Revit 46. Here, if changes are needed to be made it REVIT 46 it is possible with the updated design file consistent with the design from Vertex 40. Here, the fields that REVIT 46 requires may be extracted and uploaded to REVIT 46 where database 30 retains those fields that REVIT 46 can not maintain, for example, the Vertex-specific or Vertex rich data. A user may then make the changes in REVIT 46 and the data may then be downloaded from REVIT 46 to central database 30 and, as it is loaded, that data is merged with the previously stored rich data fields from Vertex 40. Here server/database may maintain rich data from various disparate systems, such that there is a two-way dataflow throughout the entire system 20. Here server database 30 permits feedback, real time or otherwise, between the various components. By way of further example, if a given CNC machine is unavailable it can communicate with the central database 30 and the given job may be either reassigned to another CNC machine or even scheduled to be fabricated in the field. Here, central computer 30 may tie in all pieces from the design, thru the materials ordering, thru the fabrication and kitting to final on-site construction where there is feedback between a portion of or all the elements associated with a given construction project. In alternate embodiments, server/database 30 or any component(s) of system 20 may include having small remote computers, for example, on various CNC machines or as stand alone remote servers. In addition, any suitable methods may be used to run the various elements asynchronously, synchronously or otherwise.

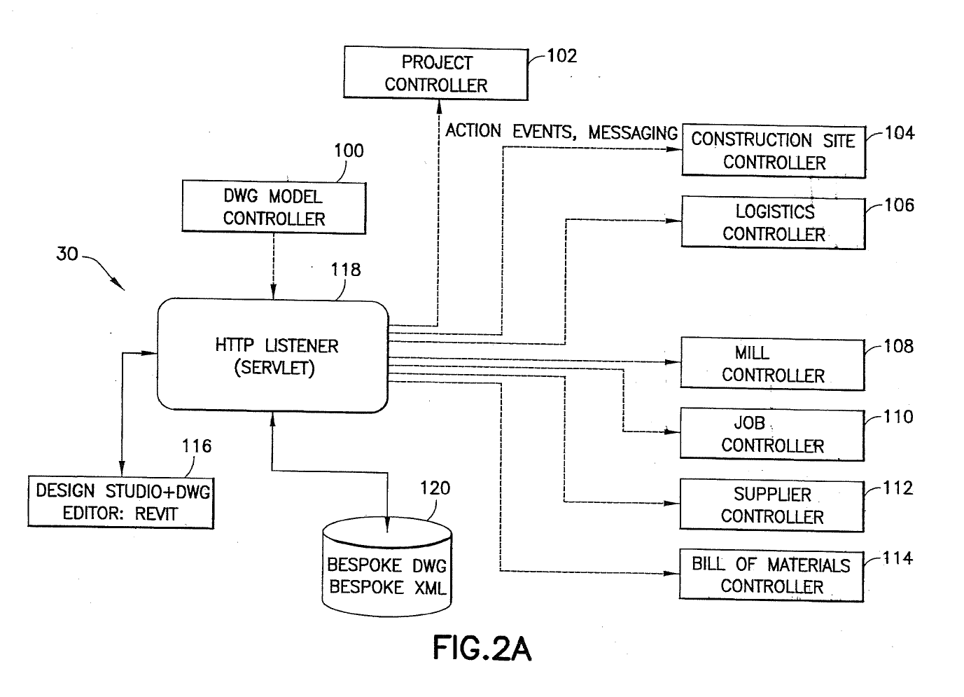

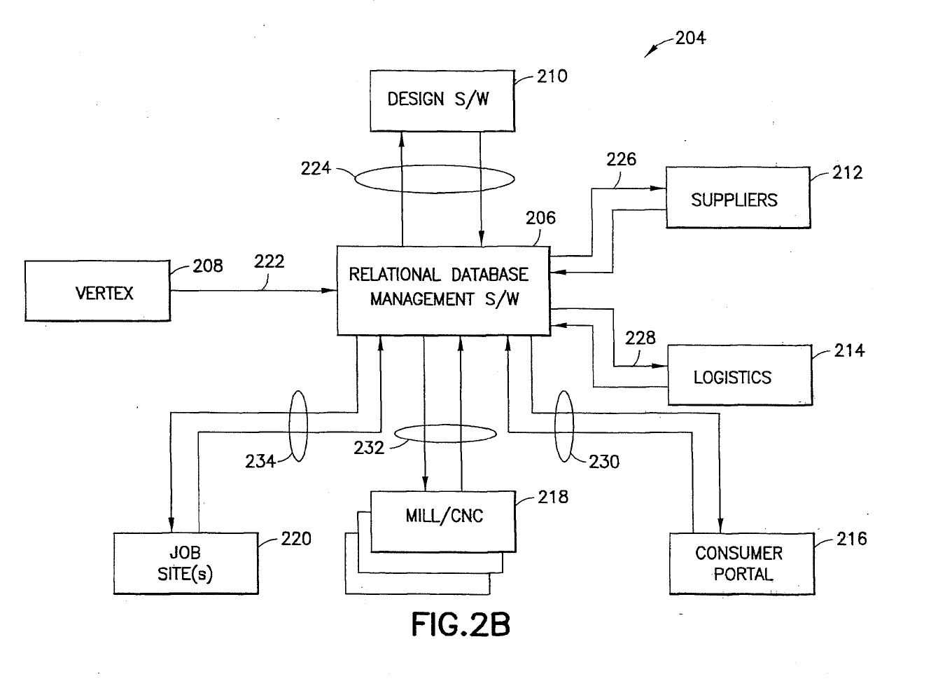

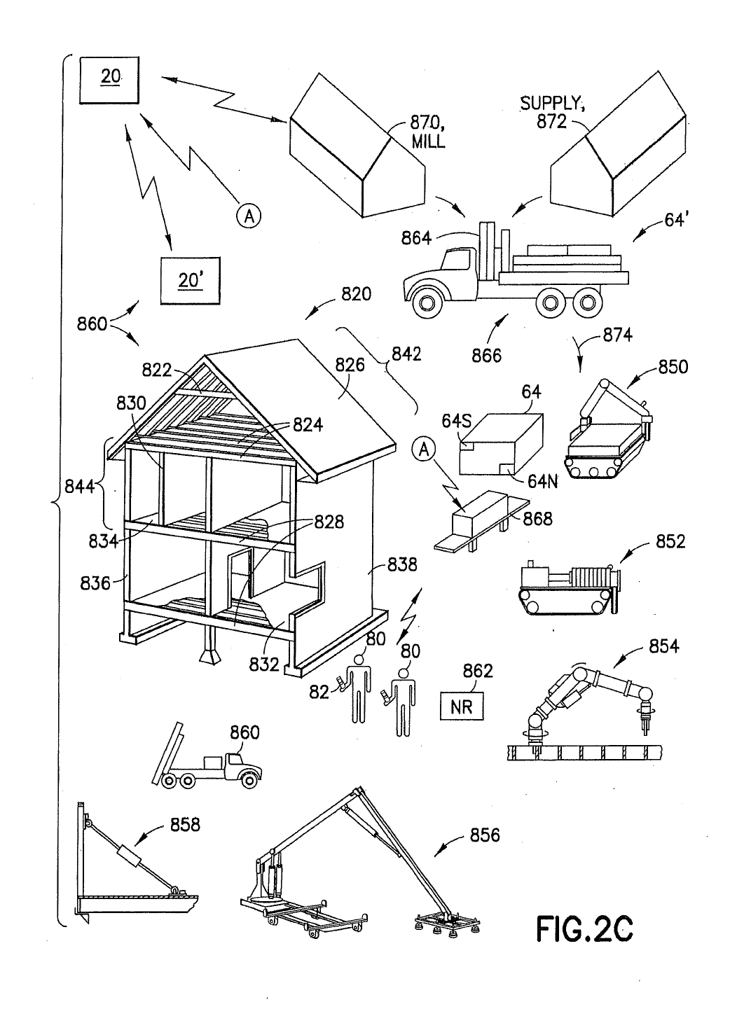

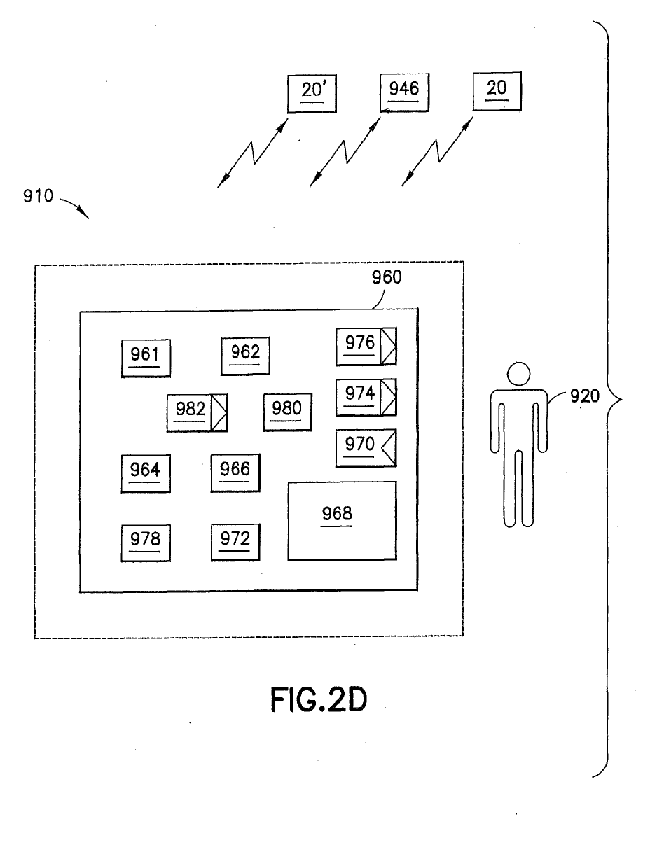

Referring now to FIG. 2A, there is shown a functional diagram of server 30 and modules 100, 102, 104, 106, 108, 110, 112, 114. FIG. 2 provides a visualization of the J2EE architecture that is blown apart as HTTP Listener 118 and database 120. HTTP listener interfaces with DWG Model Controller 100, Project Controller 102, Construction Site Controller 104, Logistics Controller 106, Mill Controller 108, Job Controller 110, Supplier Controller 112, BOM Controller 114, and Design Studio and Drawing Editor 116. Controllers 100-114 are shown as services provided within the J2EE framework. These services interact with the database or invoke a sibling service to execute an action or retrieve data, and/or status, and/or feedback from the repository.

Referring now to FIG. 2B, there is shown a functional diagram of a construction control system 204. Relational database and management software 206 interacts with Vertex design software 208, design software 210, suppliers 212, logistics 214, customer portal 216, Mill/CNC 218 and job site 220. Vertex design software 208 interacts with relational database and management software 206 with data 222 including XML files for framing, dimensions and positions, PDF files for assembly drawings and XLS files for quantities, bills of material and material data. In alternate embodiments, alternate file types may be used, for example, GBXLM (Green Building XML) or other suitable formats. Design software 210 interacts with relational database and management software 206 with data 224 including revision controlled DWG files bi-directional or otherwise. Suppliers 212 interact with relational database and management software 206 with data 226 including for example, material orders, status, delivery or otherwise. Logistics 214 interacts with relational database and management software 206 with data 228 including position, location, time and transport data. Customer portal 216 interacts with relational database and management software 206 with data 230 including status, change requests, billing, payment or otherwise. Mill/CNC 218 interacts with relational database and management software 206 with data 232 including status, CNC files, change requests or otherwise. Job site 220 interacts with relational database and management software 206 with data 234 including dispatch, instructions, status, material positions, exceptions or otherwise. Laser devices, LPS position information, hand held devices for operator input or automated input may be utilized at the job site or otherwise to record status and position of any or all components installed and when installed. By way of example, an operator may utilize a hand held device to acknowledge task completion, note exceptions or otherwise. By recording installation and position, the construction project may be self certifying and not requiring a separate visual inspection, for example, self certification for wind load may be accomplished by recording and confirming nail positions, lubber type and location, adhesive application or any suitable data as required for a given certification. Such data may, for example, include type of nails, position, depth, spacing, grade of lumber or otherwise. The data may be routed to relational database 206 to certify and record spacing or otherwise such that code compliance is ensured by the data set where database 206 may provide a compliance report to demonstrate certification with no or only partial inspection. The certification may apply to any or all aspects of the construction including lumber, joints, wiring, plumbing where the database is updated and if not to code, drives change in a bi-directional manner.

Referring now to FIG. 2C, there is shown, an isometric view of a job site and support infrastructure to build a structure having framed structure thereon in residential or commercial construction or otherwise incorporating features in accordance with an exemplary method and embodiment. Job site and support infrastructure 800 has structure 820 made of framed and sheathed components. Although the structure 820 will be described with respect to framed and sheathed components of lumber, any suitable components, for example, metal, polymer, composite, masonry or otherwise may be used. Further, although structure 820 will be described with respect to framed and sheathed components, other components prior, during or subsequent to framing of structure 820 may be applied to the present embodiments. By way of example, interior or exterior trim components, siding or roofing components, hybrid sheathing and siding components, kitchen and bath components, wall finishing components such as sheetrock or otherwise, interior or exterior masonry and supporting structures or other suitable component part or subassembly. Structure 820 may be made of roof rafters 822, ceiling joists 824, roof sheathing 826, floor joists 828, second floor wall studs 830, sub floor 832, 834, first floor wall studs 836, and sheathing 838. In alternate embodiments, more or less components may be provided. In the exemplary embodiment shown, framing material kit 64 may be provided to make up a desired structure or portion of a structure and may include components, for example, cross bracing or otherwise required to assemble the structure but not part of the completed structure. Here, structure 820 may be divided into multiple substructures with the multiple substructures defining structure 820. For example, roof 842 may be one multiple substructure where ceiling joists and second floor walls 844 may be another substructure. Job site and support infrastructure 800 may have available a number of construction modules, support modules or construction automation modules, for example, as disclosed in U.S. Provisional Patent Application Ser. No. 61/422,501 Entitled “CONSTRUCTION MATERIAL HANDLING METHOD AND APPARATUS” and filed on Dec. 13, 2010, U.S. Provisional Patent Application Ser. No. 61/362,139 Entitled “AUTOMATED STICK SYSTEM” and filed on Jul. 7, 2010, U.S. Provisional Patent Application Ser. No. 61/422,508 Entitled “CONSTRUCTION FASTENING AND LOCATING SYSTEM AND METHOD”, and U.S. Provisional Patent Application Ser. No. 61/422,476 Entitled “FRAME CONSTRUCTION METHOD AND APPARATUS” filed on Dec. 13, 2010, all of which are hereby incorporated by reference herein in their entirety. By way of example, modules such as panel cart 850, joist setter 852, placement arm 856, walking joist or rafter placement arm 854, auto level 858 or trolley and panel lifter 860. As disclosed in U.S. Provisional Patent Application Ser. No. 61/422,508 Entitled “CONSTRUCTION FASTENING AND LOCATING SYSTEM AND METHOD”, which is hereby incorporated by reference herein in its entirety a nailing device 862 may further be provided and having a locating device (LPS) in communication with controller 20 and/or 20′ or otherwise. The locating device may similarly be utilized with other automation components, tools, materials, assemblies, personnel or any suitable asset used in any aspect of the construction process. In alternate embodiments, more or less automation modules may be provided. For example, crane 864 on truck 866 may be provided or otherwise. In alternate embodiments, crane 864 may be a larger crane and provided as a stand alone crane of any suitable type on site either affixed or moveable. In alternate embodiments, truck 866 may be provided as a platform for construction, for example, where truck 866 has stick machine 868 mounted thereon and transportable to a construction site or otherwise. In the embodiment shown, stick machine 868 may incorporate features as disclosed in U.S. Provisional Patent Application Ser. No. 61/362,139 Entitled “AUTOMATED STICK SYSTEM” and filed on Jul. 7, 2010 which is hereby incorporated by reference herein in its entirety. Further, truck 866 may be provided with any suitable combination of automation modules or modules or tools and materials to assist in the construction. The construction automation modules may be provided adapted to assist in assembly of structure 820 at the job site where the at least one construction automation module is provided at the job site. Construction automation module(s) are selected and adapted to assist in assembly of structure 820 at the job site and provided at the job site. Material kit(s) 64 for the substructure(s) may be defined having components 64.1 . . . 64.n. A subset of the components are identified as automation assisted components of the material kit that may be the entire kit 64.1 . . . 64.n or a subset of the kit and are identified to be handled by one or more of the construction automation modules. The material of kit 64 may have features facilitating use of the construction automation modules, for example, jig holes, locating features, handling features, jig features, identification features or fiducials facilitating use of optical character recognition may be provided. In alternate embodiments, more or less features may be provided. Further, the components of material kit 64 may include permanent or temporary jigs, fasteners, tools, plumbing materials, electrical materials, HVAC materials, insulation, automation components or otherwise as required to complete fabrication of the construction materials contained within kit 64. As disclosed in U.S. Provisional Patent Application Ser. No. 61/422,476 Entitled “FRAME CONSTRUCTION METHOD AND APPARATUS” filed on Dec. 13, 2010, which is hereby incorporated by reference herein in its entirety and described by way of example below, the framing components may have mating fastener features, for example, pins and mating sockets that mate during assembly of the structure where the mating features may be applied to any suitable mating portion of structure 820. Definition of the substructure(s), Selection of the construction automation modules, definition of the material kit(s) for the substructure(s) including construction materials, fasteners, tools and other materials, identification of the components and subset of the components as automation assisted components of the material kit and identified to be handled by one or more of the construction automation modules may be accomplished by server 20 where server 20 may be a Residential Homebuilding Material Control System (RHMCS) 20 that may maintain item and location data real time for design, millwork and construction phases (real-time as-built). System 20 may enable efficient material ordering, scheduling, dispatch, job execution, material management, control of automation, placement of materials, location and status of materials, tools or automation, human safety (location of people) pace-setting, and compliance to codes green initiatives (e.g. Energy Star, LEED, FSC). System 20 determines what automation components will be used and plans for and puts features into the construction materials such as locating holes or features, fiducials, center of gravity locations, lift points, fixturing to accommodate automation or other suitable feature to ease and facilitate efficient completion of the structure. Feedback into system 20 may include data transmitted from automation or other modules which may be on or off site, for example, status of task or position of automation and material from local position feedback system(s) as well as data transmitted from humans 80, for example, via smart phone interface 82 with location information. Location and/or status tracking devices may be affixed to any device contributing to the completion of the structure including fabrication materials, fabricated assemblies, automation components, tools, personnel, ancillary materials, plumbing materials, electrical materials, HVAC materials, insulation, fasteners or any other suitable contributor to the completion of the structure. An example of a suitable tracking device is disclosed in U.S. Provisional Patent Application Ser. No. 61/422,508 Entitled “CONSTRUCTION FASTENING AND LOCATING SYSTEM AND METHOD”, which is hereby incorporated by reference herein in its entirety. Here, tracking devices may communicate with system 20 in a one or two way fashion, driving, for example, an automation component to the portion of the site needed or by way of further example, driving additional materials to the site based on completion status. As such, the tracking devices facilitate efficient completion of the structure. System enables streamed (lean manufacturing) as opposed to what is currently batch processing. System 20 may include full visualization capability of shop floor or construction site for remote monitoring. System 20 orders material for the kit(s) from mill 870, supply 872 or otherwise. In alternate embodiments, system 20 may order the material to be fabricated on site via stick machine 868 or via local controller 20′. As such, the material kit(s) are fabricated for substructure(s) with one or more of the components of the material kit being pre cut to length and size. Components of kit 64 may be placed in a logical order such that as components are removed, they logically are in the order of assembly and may provide all that is necessary, including tools, fasteners or otherwise to complete assembly of the construction materials. In addition to driving materials, system 82 may further drive the delivery location and sequence of delivery facilitating efficient completion of the structure. By way of example, system 20 may drive delivery of sheetrock to a floor during framing and before the floor is enclosed such that availability to the workers is immediate and special equipment is not required, for example, to deliver the sheetrock through a window. As previously described, the components may comprise any desired components that make up the completed structure in addition to supporting components if needed. Although shown made up of stick lumber, kit 64 may contain combinations of materials, for example, stick lumber and sheathing and/or flooring and/or fasteners, tools plans or otherwise required to complete the structure or portion of the structure. Alternately, kit 64 may include prefabricated sub assemblies, for example, wall or floor or other suitable sections or portions which may include components. The lumber may be cut to size manually, semi automatically or automatically on any suitable platform. A suitable example is stick machine 868 is disclosed in U.S. Provisional Patent Application Ser. No. 61/362,139 Entitled “AUTOMATED STICK SYSTEM” and filed on Jul. 7, 2010 which is hereby incorporated by reference herein in its entirety. Stick machine 868 may be provided to manufacture lots of lumber, for example CNC cutting, identification, drilling for electrical or plumbing, marking circuits, electrical boxes etc. . . . . In alternate embodiments, more or less functions may be provided. Exemplary stick machine 868 may be an automated system that produces stick-frame construction components, for example, studs, top plates, bottom plates, joists, rafters, blocking or otherwise from standard dimensional lumber. Machine 868 may receive CAD data translated from a framing model in server 20 and may reside on site or off site, for example within mill 870. Stick machine 868 cuts boards to length and may be provided with adjustable miter and bevel, drills holes for electrical and plumbing, marks, for example, board ID, stud locations, hole ID—electrical circuit or plumbing ID, electrical outlet locations, switch locations, data cables or otherwise. Machine 868 may also drill mating features, such as holes or slots for pinned connections to bottom of panels, top of panels, at stud locations or otherwise to permit alignment or otherwise and may install mating pins or features. Stick machine 868 may be fed 2″×3″ through 2″×12″ lumber and may prompt a user to load appropriate board length that minimizes waste of parts to be produced. Machine 868 may be portable to job site or location proximate home construction or located remote such as at site 870. Kit 64 may be assembled at job site 800 as material is fed from machine 868. Alternately, Kit 64′ may be delivered 874 and assembled in real time on site 800. Alternately, Kit 64 may be assembled at a site 870 different than job site 800 and transported or shipped to job site 800. Tools, automation or otherwise may be provided to facilitate assembly. In alternate embodiments, any suitable tools or automation may be provided to facilitate assembly. Additionally, a portion or all of the framing components may have identification indicia, with the identification indicia indicating where the mating framing components are to mate and/or indicating which of the mating framing components mate and/or an order that the framing components are to be assembled, a component identification, unique or by group or otherwise and/or any suitable identification indicia. In alternate embodiments, any suitable mating feature, fastener or identification indicia or otherwise may be provided on the components of kit 64 to facilitate ease of assembly, fool proof assembly or ease of alignment. In the embodiment shown, the framing components 64 are pre cut to length and size to form at least a portion of the structure 820. By way of example, kit 64 may comprise the framing and sheathing required to assemble the roof structure of structure 820 or alternately, one or more walls having a kit with mating components or floors or otherwise. Material kit 64 or 64′ may be delivered to the job site via truck 866 or other suitable delivery method. Alternately, material kit 64 or 64′ may be fabricated and delivered on site. One or more of the automation assisted components, tools or otherwise may be scheduled and provided on site where the material kit defined for the automation component, tools or otherwise may be provided. By way of example, panel cart 860 may have a pallet of panels loaded from lot 84′ via crane 864. The components of the kits may be assembled by substructure utilizing the automation modules tools or other predetermined assets, ultimately forming the structure using the automation modules that may work in conjunction in combination with operators and workers.

Referring now to FIG. 2D, there is shown a functional diagram of tracking system 910 having LPS or tracking device 960. System 910 may be any suitable construction asset or material where bi directional communication is desired with server 20. For example, system 910 may be a construction asset or tool such as a manual, semi autonomous or autonomous vehicle that is controlled by the RHMCS or server 20 or alternately may be directed by one or more operators 920 or local or onboard controller 20′ or local controller 946. Location and/or status tracking device 960 may be affixed to system 910 or any device contributing to the completion of the structure including fabrication materials, fabricated assemblies, automation components, tools, personnel, ancillary materials, plumbing materials, electrical materials, HVAC materials, insulation, fasteners or any other suitable contributor to the completion of the structure. Here, the tracking devices may communicate with system 20 in a one or two way fashion, driving, for example, system 910 to the portion of the site needed or by way of further example, driving additional materials to the site based on completion status. As such, the tracking devices facilitate efficient completion of the structure. In alternate embodiments, more or less functions may be provided. Feedback into system 20 may include data transmitted from system 910 which may be on or off site, for example, status of task or position of system 910 from local position feedback system(s) as well as data transmitted from humans, for example, via a smart phone interface with location information. Positioning data within device 960 or otherwise may be captured by any suitable position system including gps, laser, bar code, OCR or any suitable scanner where the system may create a map space with partial or full content as required. For example, the position system may identify on site locations of “landmarks” and fiducials in map space where internal “GPS” systems confirm position and variances. In alternate embodiments, inertial or any other suitable position system, such as laser based systems may be provided. Further, in alternate embodiments, parallel positioning sensors may be used to “filter” spurious positioning signals. A database within control system 20 may be updated continuously with status and state data where a state model is updated as well. By recording installation and position, the construction project may be self certifying and not requiring a separate visual inspection, for example, self certification for wind load may be accomplished by recording and confirming nail positions, lubber type and location, adhesive application or any suitable data as required for a given certification. Such data may, for example, include type of nails, position, depth, spacing, grade of lumber or otherwise. The data may be routed to the database of system 20 to certify and record spacing or otherwise such that code compliance is ensured by the data set where the database may provide a compliance report to demonstrate certification with no or only partial inspection. The certification may apply to any or all aspects of the construction including lumber, joints, wiring, plumbing where the database is updated and if not to code, drives change in a bi-directional manner. Further, multiple tracking devices 960 may be affixed to any suitable construction asset, material or otherwise for the purposes of system 20 tracking progress of construction, certification, staging of materials or assets, providing for safety interlocks or otherwise. By way of example, a tracking device 960 may be affixed to a crane and another positioning or tracking device 960 on a worker where system 20 provides for stoppage of the crane or an alarm via device 960 where an unsafe condition is detected. In one embodiment, system 910 takes coordinates from the RHMCS or server 20 and verifies its position using LPS 960. For example, where system 910 may be a nailing system, once at a nailing location, system 910 fires nails in line with joists and as nails are fired, data associated with the nailing, travel or otherwise may be stored in controller 20′ and/or transmitted to RHMCS 20 or controller 946 for verification and certification purposes. A combination of inertial navigation within system 910 or device 960, line or load marks and location device 960 may detect location within ½″ or less or otherwise. Further, land marks such as board edges, fiducially marks or features from the manufacturer or otherwise may provide coarse location with fine location being provided by sensing joists or otherwise. In alternate embodiments, other suitable indicators may be provided. In alternate embodiments, more than one system 910 may be provided for redundancy and/or speed. In the embodiment shown, controller 20′ or LPS 960 may communicate with local controller 946 or remote controller or server 20. As such, system 910 may communicate status, progress or otherwise and may receive commands, data or otherwise such that system 910 and RHMCS 20 may be synchronized substantially in real time or periodically as required. An example of data may include downloading of topography of wall or floor panels, joists or studs, nail or fastener spacing, materials or otherwise as needed from system 20. As a further example, land mark locations may be updated in real time to accurately determine a location. As a further example, such as when an operation, such as when a fastener is put in, system 910 may report back to RHMCS 20 that the action was complete. Alternately, system 910 may buffer data and update RHMCS 20 periodically. By way of further example, system software in RHMCS 20 or controller 946 may download an image or data of the construction site or tasks to be performed. As such, system 910 may or may not have to be connected to the system software continuously. Interacting with the local controller or system software 946 or server 20, system 910 may know in real time what boards or panels or sheathing have been installed and interlocks may be provided to sense the material or otherwise where final positioning may be provided, for example, tracking a laser line or pattern on the construction site. In the embodiment shown, location device 960 may be fixed to system 910 or alternately may be fixed to any suitable other personnel, material, tool, equipment or system within the construction site or being supplied to the construction site, for example, tools, fasteners, building materials, completed panels or structures assets or otherwise. In alternate embodiments, any suitable number of positioning or tracking devices 960 may be provided on any suitable number of assets. Location device 960 may have any suitable combination of sensors or devices, for example, 6 axis accelerometer 961, 3 axis gyroscope 962, cpu 964, memory 966, power source 968 one or more cameras 970, 972, laser 974, bar code reader 976, hall detection device 978 and radio frequency identification device 980. The location device may have any suitable communication capability 982, such as with Bluetooth, WIFI, radio, cellular or other suitable communication device. The module 960 may be provided on a single pc board or as multiple integrated components. In the embodiment shown, accuracy of +/−one inch may be provided for two minutes over thirty feet where system 960 is operated independently. In alternate embodiments, more or less accuracy may be provided depending on component precision. In alternate embodiments, more or less components may be provided on device 960. In the embodiment shown, additional accuracy is provided with interaction with server 20 and by leveraging knowledge of the use case in commercial and residential construction. For example, additional accuracy may be obtained by applying knowledge that from time to time system 910 stops and by system 960 knowing the use case, system 960 is aware that drift is unlikely. As such, system 960 may ignore in software any drift when such a known condition exists By way of further example, using dynamic landmarks fed back from system 20 to LPS 960, LPS 960 may be aware of what has been placed and by virtue of cad and server data, may be aware of what suppliers material is placed and, as such, may use known marks on the materials as landmarks, for example, known lines on a known manufacturers sheathing to provide nailing locations to controller 946 or 20′ of system 910. In application, the independent accuracy of the LPS used in combination with data collected by LPS 960 from known landmarks and from server 20 or otherwise may yield improved accuracy, for example, may give +/−0.030″ accuracy where the travel distance from landmark to landmark may be small or otherwise. In alternate embodiments, any suitable accuracy may be obtained with the combination of local data acquisition, applied knowledge of the use case (residential or commercial construction) and applied knowledge of data available from server 20 or otherwise. By way of further example, on tools, such as system 910, the gyroscope(s) may have anomalies when disturbed, such as when nailing. As the software in LPS 960 may be aware when system 910 stopped and nailed, LPS 960 may ignore any data that would indicate drift or otherwise during the nailing event. In alternate embodiments, LPS 960 may be put on other tools, materials or workers such that system 10 or other material or tools may stay clear and avoid safety issues or otherwise. For example, LPS 960 may be put on the end of a crane, to deliver loads where planned and interlocked for safety, for example, to avoid personnel, other placed loads or otherwise. In alternate embodiments, any suitable combination of LPS(s) may be provided on any suitable combination of tools, materials or other assets used in commercial or residential construction and used in conjunction with server 20. In alternate embodiments, LPS(s) may be applied within any suitable use case in conjunction with or separate from commercial or residential construction.

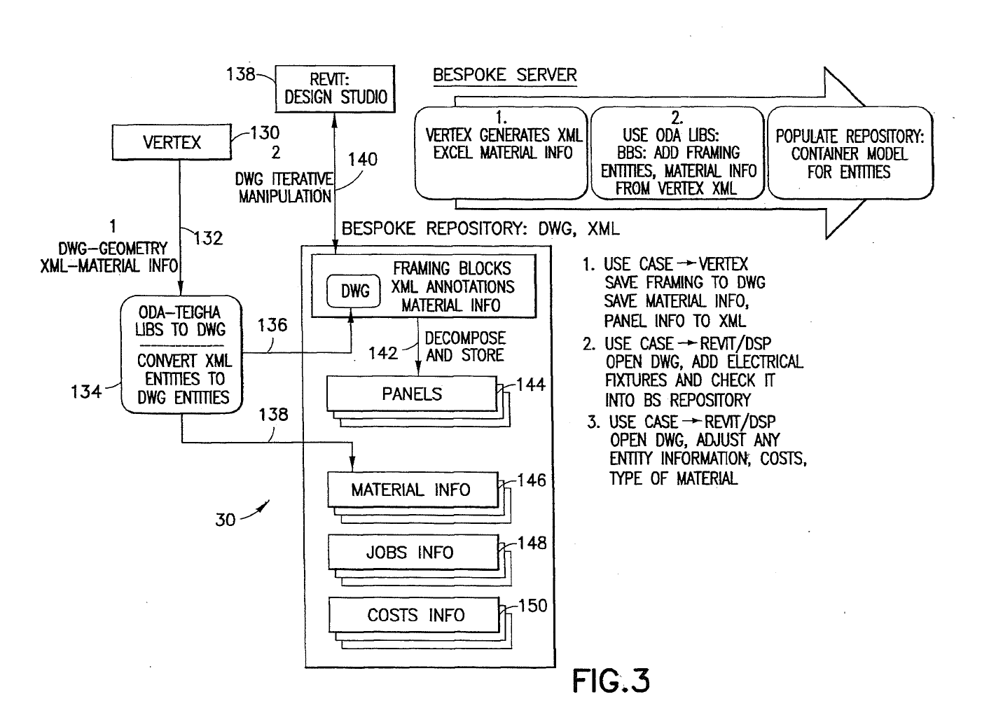

Referring now to FIG. 3, there is shown a functional diagram of a server and repository 30. In the embodiment shown, Vertex 130 generates .DWG Geometry and .XML material information 132 where framing data/ODA-Teigha Library's are converted to .DWG and .XML entities are converted to .DWG entities 134 and deposited in the repository as .XML and .DWG files 136, 138. Database 30 accesses Revit: Design Studio 138 and through .DWG iterative manipulation 140, by way of example, Revit: Design Studio 138 opens .DWG's and adds fixtures and checks the files back into the repository where subsequently Revit: Design Studio 138 opens .DWG's and adjusts entity information, costs, type of material or otherwise. Subsequently, the data is decomposed and stored 142, for example, as panels 144 or otherwise. Further, data such as material information 146, job information 148 and cost information 150 may be provided within repository 30. In alternate embodiments, any suitable data or information relating to the project may be retained and varied within repository 30.

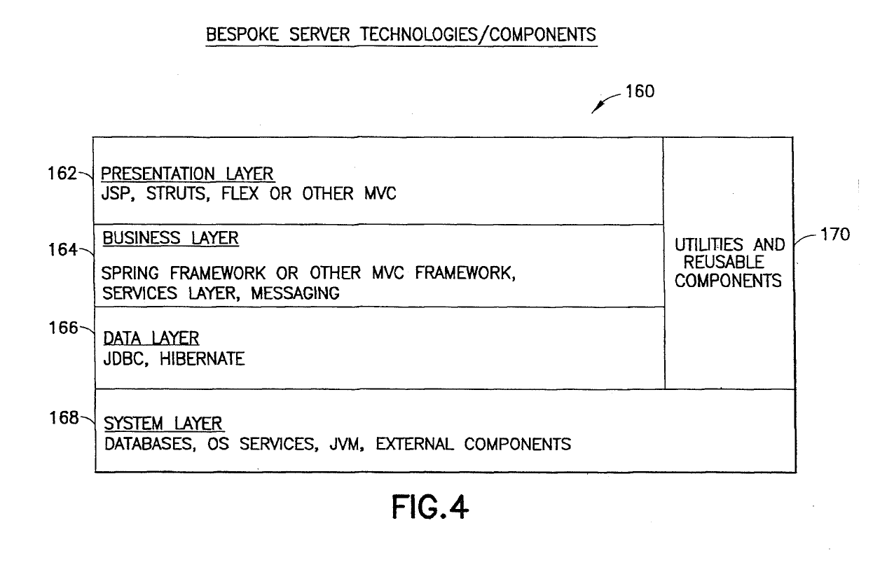

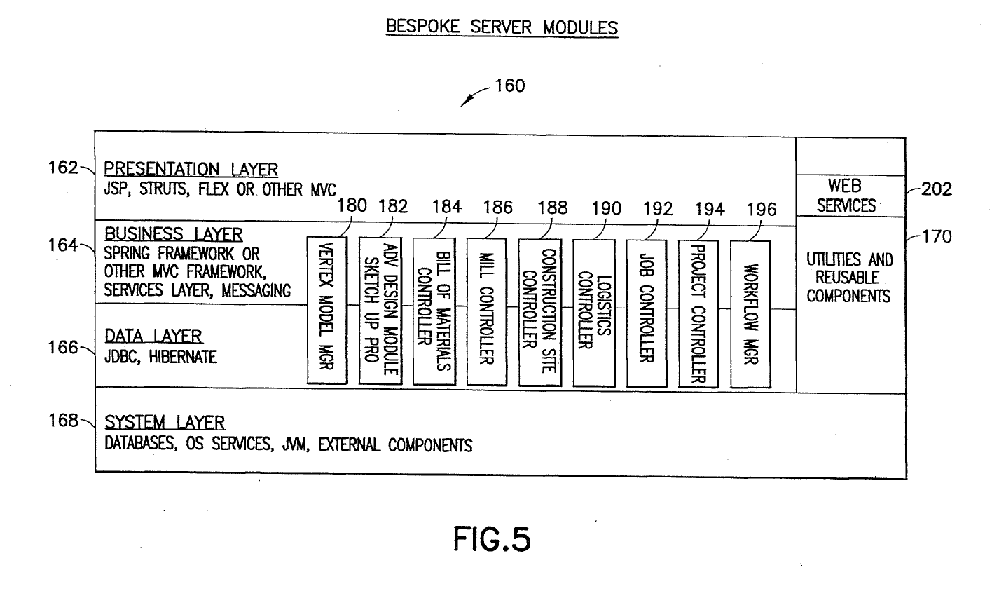

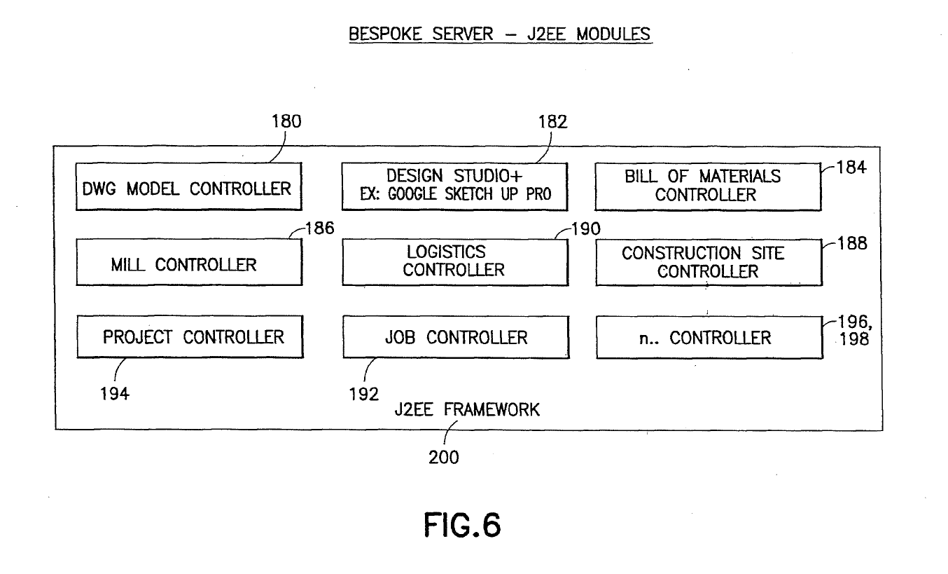

Referring now to FIG. 4, there is shown a diagram of server software components. Server software 160 is provided with 4 layers, presentation layer 162, business layer 164, data layer 166 and system layer 168. Layers 162, 164 and 166 comprise utilities and reusable model view controller framework components 170. Presentation layer 162 has JSP, Struts, Flex or other MVC. Business layer 164 has Spring framework or other MVC framework, Services Layer and Messaging. Data layer 166 has JDBC and Hibernate. System layer 168 has Databases, OS Services, JVM and external components. Referring also to FIG. 5, there is shown a diagram of server modules within the server software components. Between business layer 164 and data layer 166 resides modules 180-196 including Vertex Model Manager 180, Adv. Design Module Sketch Up Pro 182, BOM Controller 184, Mill Controller 186, Construction Site Controller 188, Logistics Controller 190, Job Controller 192, Project Controller 194 and Workflow manager 196. Referring also to FIG. 6, there is shown a diagram of server J2EE modules 180-196 within the J2EE Framework 200. In alternate embodiments, any suitable number n of controllers 198 suitable to the construction of the project may be provided. In the aforementioned disclosed embodiment, the bespoke server is shown as an n-Tier J2EE enterprise server. The above figures show the layers in the server architecture for Bespoke Server 30 as a layer cake model. Utilities are provided for remote communication utilizing Messaging, Web Services 202 or otherwise where remote terminals (please see FIG. 1) will be able to send messages in a secure persistent fashion that is being processed at the server.

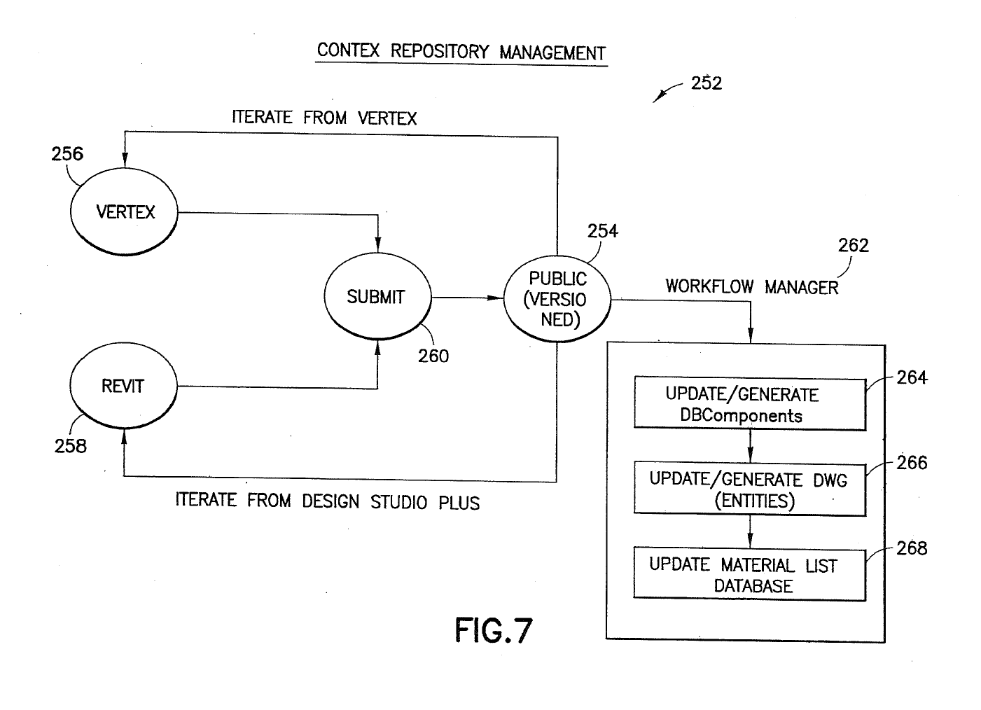

Referring now to FIG. 7, there is shown a diagram of content repository management 252. Public versioned design files 254 are iterated from vertex 256 and/or Revit 258 through design studio plus and re submitted 260 to an up revised public versioned file 254. Workflow manager 262 takes the versioned files and updates and generates DB Components 264, updates and generates DWG entities 266 and updates material lists 268 according to the revised design. The basic versioning is implemented in the relational database for every homebuilding or construction project through its entire lifecycle.

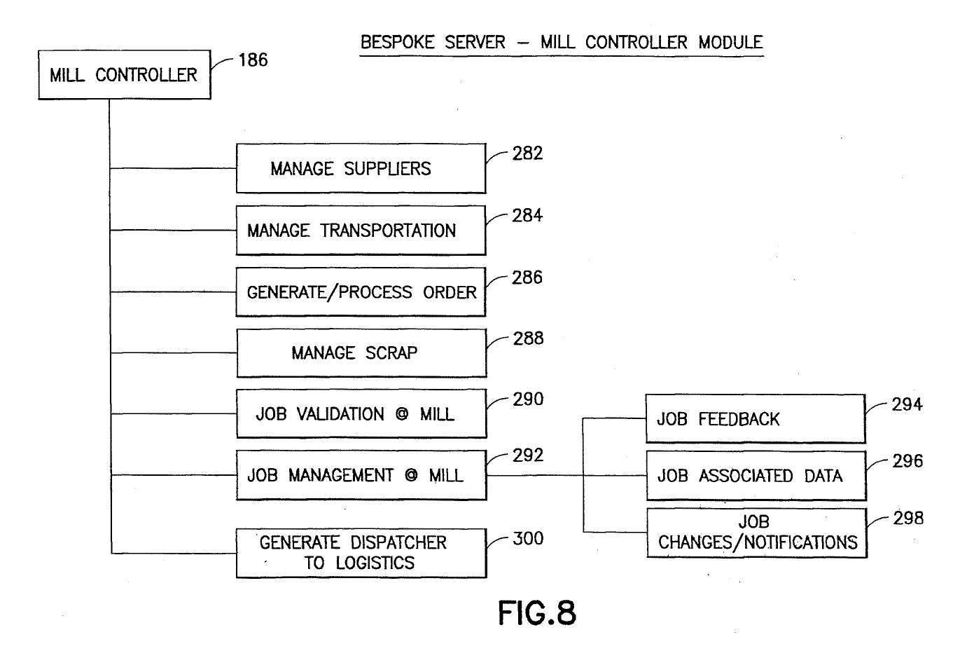

Referring now to FIG. 8, there is shown a functional diagram of mill control module 186. Functionally, mill control module 186 manages suppliers 282, transportation 284, generates and processes orders 286, manages scrap 288, validates orders at the mill 290, manages jobs at the mill 292 and generates dispatcher to logistics 300. Managing jobs at the mill 292 includes job feedback 294, job associated data 296, and job changes and notifications 298. In alternate embodiments, more or less functions may be provided.

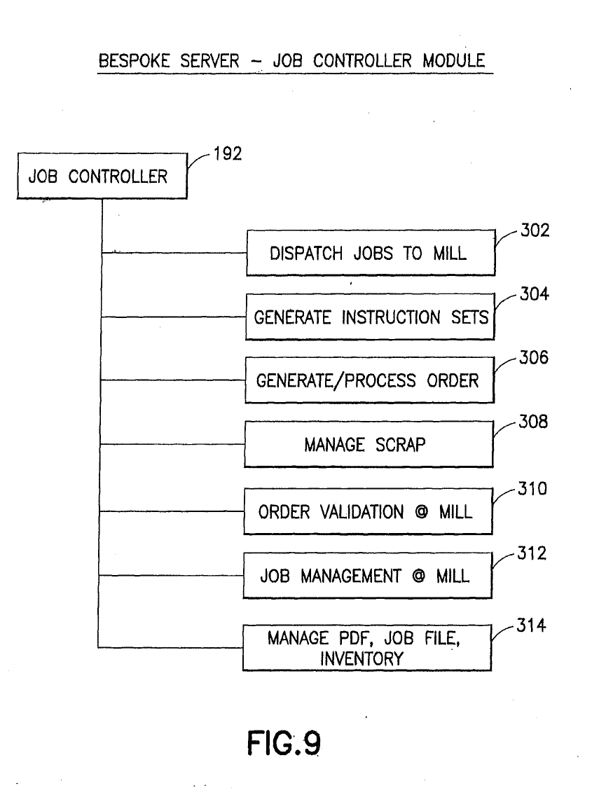

Referring now to FIG. 9, there is shown a functional diagram of a job control module 192. Functionally, job control module 192 dispatches jobs to the mill 302, generates instruction sets 304, generates and processes orders 306, manages scrap 308, validates orders at the mill 310, manages jobs at the mill 312 and manages PDF, job file and inventory 314. In alternate embodiments, more or less functions may be provided.

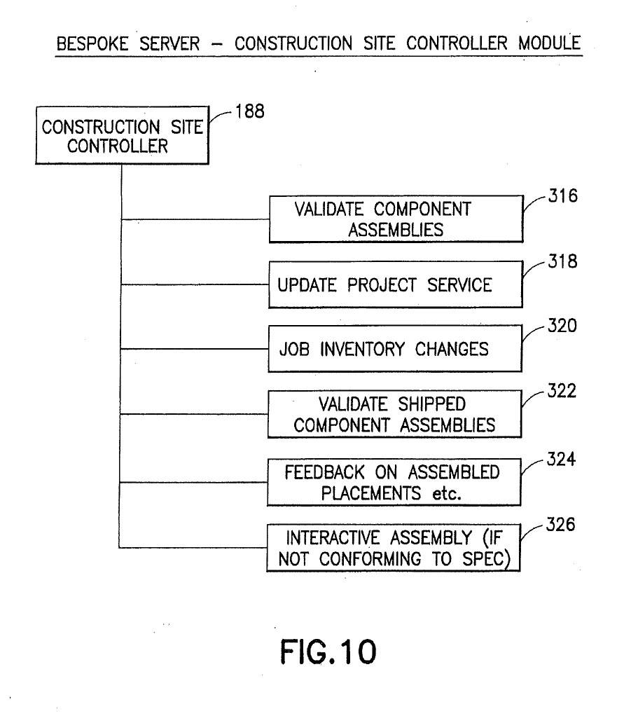

Referring now to FIG. 10, there is shown a functional diagram of a construction site control module 188. Functionally, construction site module validates component assemblies 316, updates project service 318, manages job inventory changes 320, validates shipped component assemblies, provides feedback on assembled placements etc. and provides iterative assembly 326, for example, if not conforming to specification. In alternate embodiments, more or less functions may be provided.

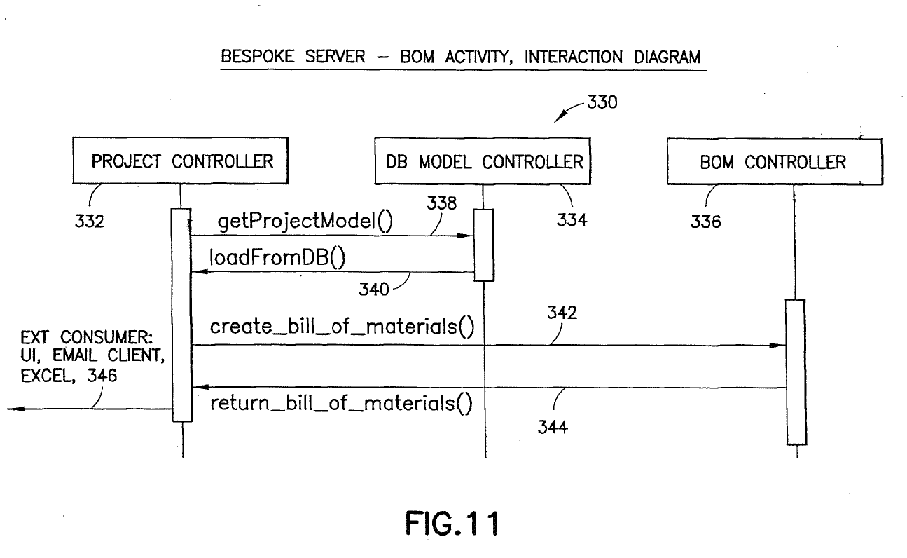

Referring now to FIG. 11, there is shown a BOM activity interaction diagram 330. In diagram 330, project controller 322 requests 338 the project model from DB Model Controller 334 returning 340 the model. Project Controller 332 then requests 342 BOM Controller 336 for BOM on certain entities. BOM Controller 336 will return 344 the information for the same entities (as PDF).

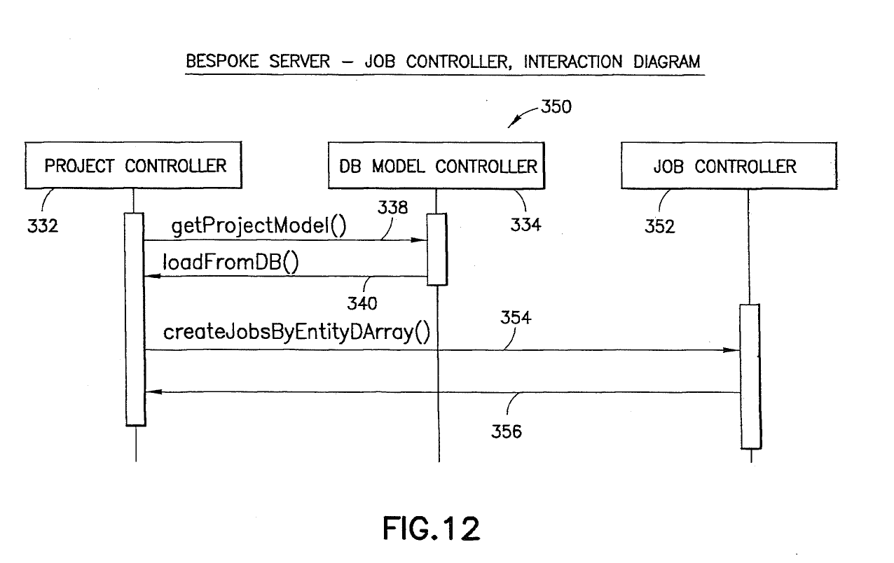

Referring now to FIG. 12, there is shown a job controller activity interaction diagram 350. In diagram 350, project controller 322 requests 338 the project model from DB Model Controller 334 returning 340 the model. Project Controller 332 then requests 354 Job Controller 352 with an array of entity ID's. Job Controller 352 will return 356 the job files for the same entities.

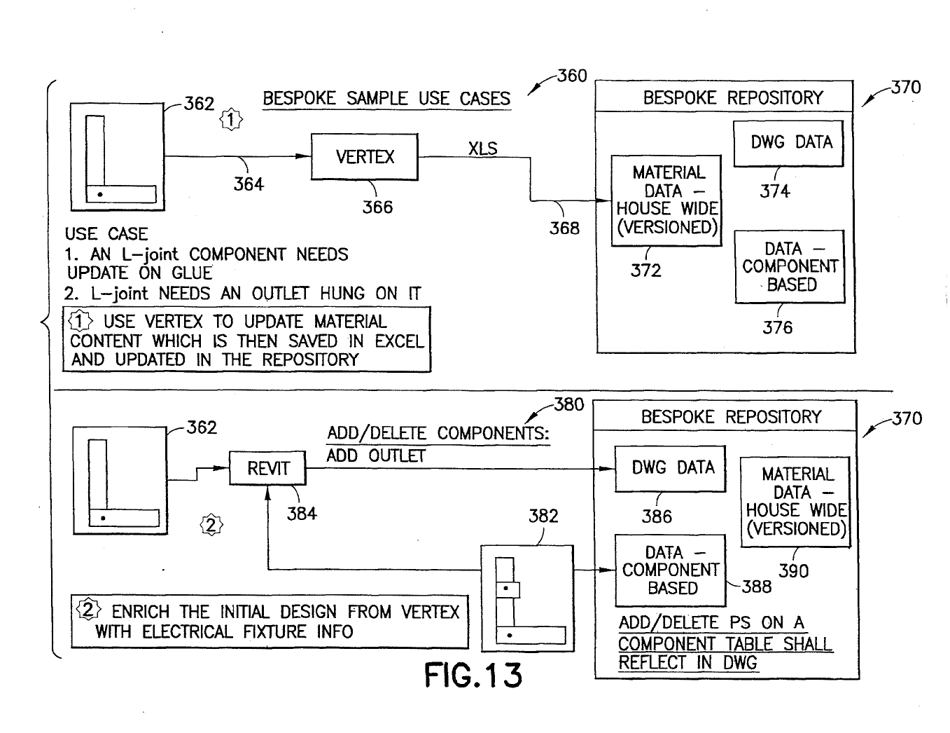

Referring now to FIG. 13, there is shown a diagram of a use case 360, 380. In the embodiment shown, L joint 362 is identified as requiring glue. The L joint 362 is defined 364 in vertex 366 where the design and material content is updated and saved in excel as a .xls file and saved 368 in the repository 370. Repository 370 saves revision controlled material data and updates and pushes the change to other data, such as .dwg data 374 and component based data 376. In the event joint 362 requires adding or removing of components, such as an outlet 382, the L joint 362 is updated in Revit 384 where the design and material content is updated and saved in the repository 370. Repository 370 updates and saves revision controlled .dwg data 386 and material data 390 and updates and pushes the change to other data, such as component based data 388. In the embodiment shown, Revit 384 is used as a CAD system for editing and drives updated data to relational database 370, for example, data related to geometry and attributes where database 370 updates bills of material, position, logistics or otherwise based on the update.

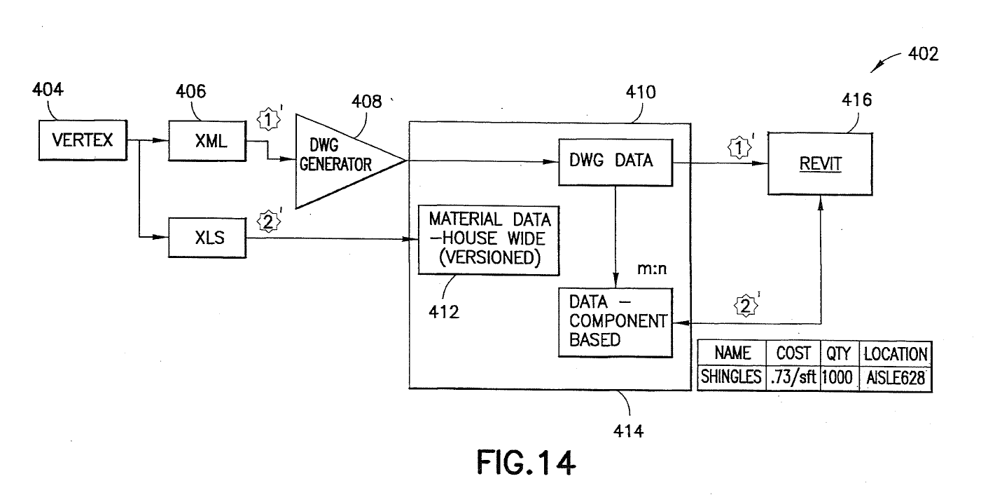

Referring now to FIG. 14, there is shown a diagram of a use case 402 showing workflow of data and interaction between Vertex 404, Revit 416 and Repository 414. There are two paths: 1′. The data in XML format specific for the model, geometry and 2′. The database of materials in Excel Spreadsheet. The XML data is input to a DWG converter, for example, a custom program. During the conversion process, the DWG entities will be extracted and saved in component database 414 referenced by the project. For example, this snippet of DWG will provide the material list for the component such as a wall panel, roof or floor etc. The Bi-Directional flow of data is achieved with entity pointers of DWG referenced in the database 414. By way of example, an electrical outlet hung on a component such as a panel can be deleted from the component in database view triggering an update to DWG file where the panel is identified and the electrical outlet, called a block in CAD terms is deleted from the drawing. Similarly if an electrical outlet is added on the same panel via Design Studio, then the necessary reference in the database component should be updated. This involves building a component library and a relationship engine to map the drawing entity to the database entity. The amount of operations done in this bi-directional flow may be limited to few deletions. In the embodiment shown, Vertex 404 generates XML or XLS 406. DWG generator 408 uses XML file 406 to regenerate DWG 410. XLS 406 is used to generate versioned material data 412. In alternate embodiments, additional output(s) may be provided from Vertex, for example, e Vertex also generates material takeoffs in XLS that are house wide. Administer in the database 414 for Vertex is shown as one way data transformation. REVIT Architecture 416 is used to enrich the model in DWG format. Using ODA Teigha Libs or RealDWG SDK (native to AutoCAD, also used by REVIT), component data shall be saved in Bespoke database 414. This database 414 can be manipulated and synched with the DWG file showing Bi-Directional flow between Revit 416 and database 414.

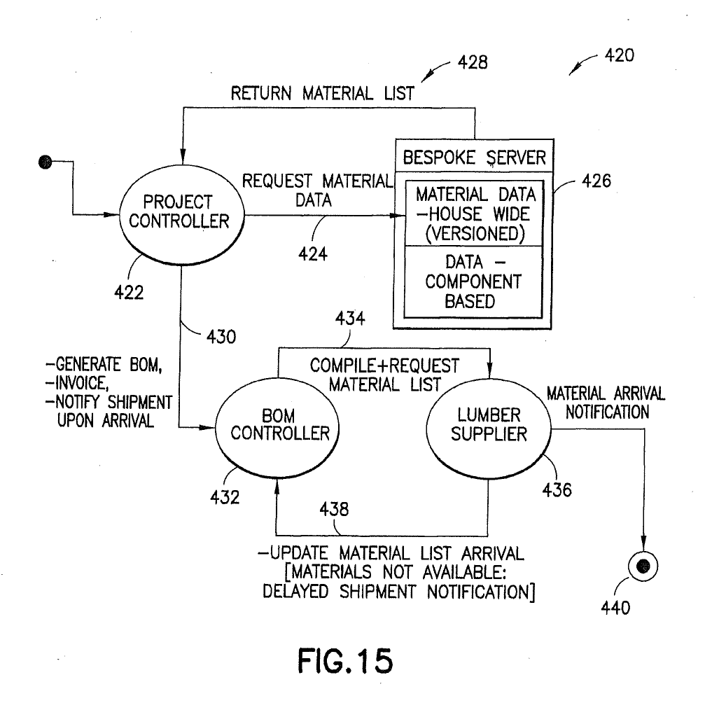

Referring now to FIG. 15, there is shown a diagram of a use case 420 where project Controller 422 is scheduling a part of new project for mill where the project controller 422 decided to begin building the components. Scheduler has decided to start the project for Mansfield. An initial request 424 to the server, will retrieve the components necessary for this part of the schedule via a Request Material List 424 from Bespoke server for project. A material list is computed from the database 426 and sends material info to suppliers 434, for example, by email. This list of materials is sent to the BillOfMaterials service 432 which then makes a request to the Lumber supplier 436 and constantly updates 438 any events arising from the lumber supplier 436. Notification/Status 438 from Lumber supplier is updated in server, for example, by manual input. The termination of this activity is usually the shipment 440 of materials followed by arrival confirmation of materials at the mill.

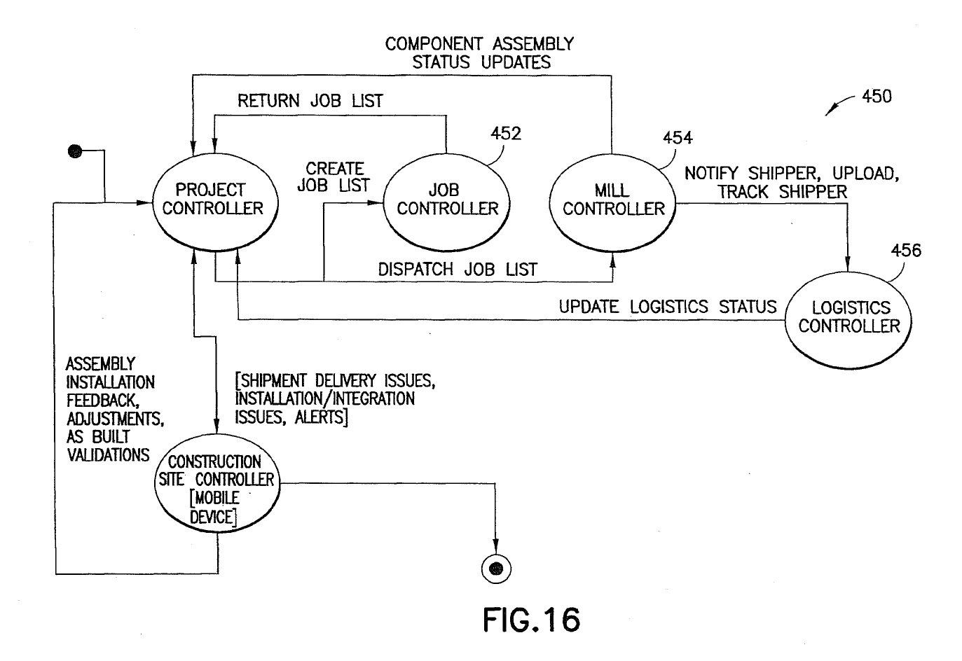

Referring now to FIG. 16, there is shown a diagram of a use case 450 showing the Life Cycle of a scheduler starting a project to finishing such as the Lifecycle of a scheduled operation. Use case 450 describes the necessary actions after the arrival of materials. The builder has decided to schedule the project for the mill. Here, the job controller 452 gets data (XML) which generates the jobs and dispatches them to the mill controller 454, for example, a J2EE service. Feedback mechanism is engaged to get the status of the individual jobs for this entire operations. Once the assembly of these jobs is done, a logistics controller 456 is notified for shipment to the construction site. During the shipment, a GPS tracker is enabled to receive input from the truck into the system regarding the consignment and status updated. Upon arrival at the construction site, the shipment is retrieved from the truck and validated against the operations. This validation is then input into the Bespoke server as status updates. Later on when the components are built into the project at the site, feedback is provided about the success or adjustments needed for a small subset of components.

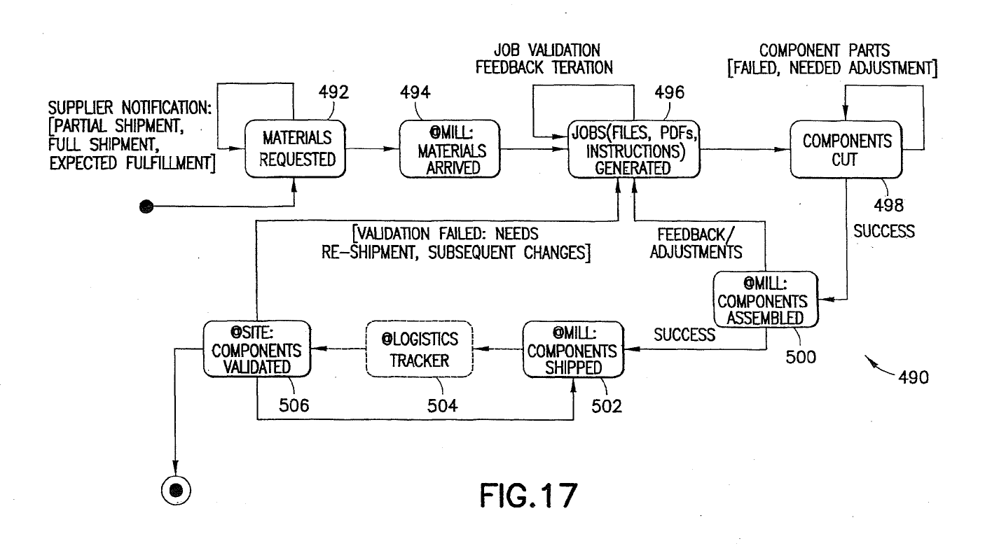

Referring now to FIG. 17, there is shown a diagram of a use case 490 showing state transitions of starting a project to finishing at construction site. Exemplary use case 490 show the same lifecycle as state machine transitions. The use case 490 shows a state transition diagram for the lifecycle of a project. The operation starts by dispatching a bill of material to a supplier 492. Shown is an iterative process where the supplier may or may not fully ship the materials and as such the status is updated on a continuous basis. After the status is updated to shipment arrived 494, the jobs for CNC machines are generated 496 and the items are fabricated 498 and assembled 500 per CNC code. The assembled component status is updated for “wait to ship” on successful completion of jobs at the mill. The components are then tagged and shipped 502 and tracked in real time basis via Logistics Tracker 504 until delivery at the construction site 506.

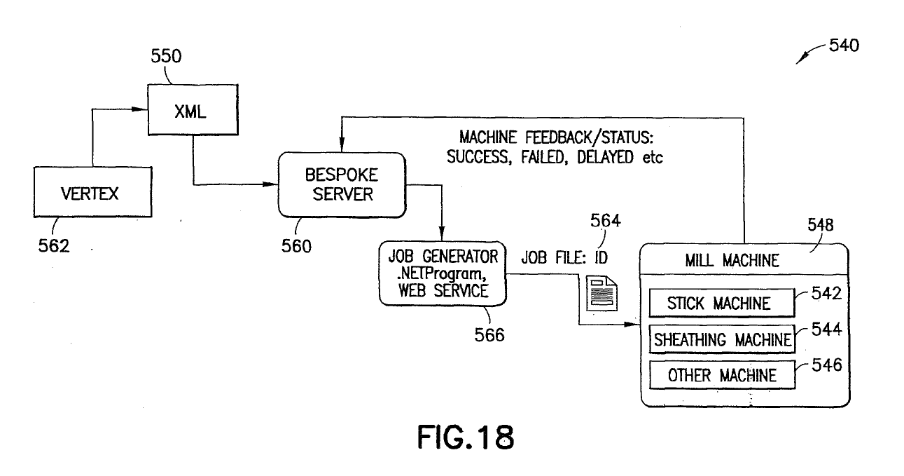

Referring now to FIG. 18, there is shown diagram 540 showing CNC information flow to a Stick Machine 542, sheathing machine 544 or any suitable machine at mill machining center 548 and controlled by Mill Service Controller. In the exemplary embodiment, exemplary stick machine 542 is provided to manufacture lots of lumber, for example CNC cutting, identification, drilling for electrical or plumbing, marking circuits, elec boxes etc. . . . . In alternate embodiments, more or less functions may be provided. Exemplary stick machine may be an automated system that produces stick-frame construction components, for example, studs, top plates, bottom plates, joists, rafters, blocking or otherwise from standard dimensional lumber. Machine 542 receives CAD data 550 translated from framing model in server 560. Stick machine 542 cuts boards to length and may be provided with adjustable miter and bevel, drills holes for electrical and plumbing, marks, for example, board ID, stud locations, hole ID—electrical circuit or plumbing ID, electrical outlet locations, switch locations, data cables. Machine 542 can also drill holes for pinned connections to bottom of panels, top of panels or at stud locations to permit alignment. Stick machine is fed 2″×3″ through 2″×12″ lumber and prompts user to load appropriate board length that minimizes waste of parts to be produced. Machine 542 may be portable to job site or location proximate home construction. The stick machine controller is a .NET framework on a windows machine that can accept an incoming CNC data, for example XML data 550 or otherwise from Vertex drawings to generate a flat file with CNC commands, data and information. Vertex tool 562 shall generate XML data 550 for a specific construction entity such as a wall or roof, floor etc. of the house. XML data 550 is then parsed and a job file (CNC code) 564 is generated via this controller software 566. The controller software 566 then submits the program details as a “driver job” to the machine 542. It is a specific set of CNC instructions that will engage the machine to either draw a marker, drill a hole or cut the stick at specific locations.

In accordance with one exemplary embodiment, a building material and workflow control system adapted to manage workflow associated with building of a construction project at a job site. The building material and workflow control system has a server having a processor and a database. The processor is programmed to identify a construction sequence of the construction project. The processor is further programmed to identify kits of assets and materials associated with respective portions of the construction sequence. The processor is further programmed to identify and generate assembly features on the materials related to assets characteristics in the respective portion of the construction sequence. The processor is further programmed to provide and stage the kits of assets and materials from a source to the jobsite utilizing real time dynamic knowledge of an erection state of the building at the job site.

In accordance with another exemplary embodiment, a residential homebuilding material and workflow control system is provided to manage items and workflow information associated with homebuilding of a residential construction project at a job site. The residential homebuilding material and workflow control system has a processor programmed to maintain a database having temporal data associated with real time dynamic knowledge of the items and the workflow. The temporal data includes a dynamic erection state during different phases of erection of the construction project. The processor having a communication interface communicably connecting the processor to the job site, the communication interface being configured for bi-directional communication between processor and job site. The erection state is registered by the processor from bi-directional communication between the database and assets utilized at the job site.

In accordance with another exemplary embodiment, a construction control system is provided adapted to manage items and workflow associated with building of a construction project. The construction control system has a processor with a database having real time dynamic knowledge of the items. The real time dynamic knowledge of items includes a state of construction of the items and a location of the items from initialization of the item into the construction project to final employment of the item in the construction project.

In accordance with another exemplary embodiment, a construction control system is provided adapted to manage items and workflow associated with building of a construction project. The construction control system has a processor with a database having real time dynamic knowledge of the items. The real time dynamic knowledge of the items includes information and data in the database identifying at least one predetermined characteristic of an item based on both a design condition and a variance from the design condition. The at least one predetermined characteristic of the item includes information related to a variance relative to the design condition.

In accordance with another exemplary embodiment, a construction control system is provided adapted to interface between first and second construction modules and further is provided adapted to manage data associated with building of a construction project. The construction control system has a server having a processor and a database. The server is adapted to extract second construction module data related to the second construction module from first construction module data associated with the first construction module. The server is adapted to modify the second module data as modified second construction module data. The server is adapted to extract a portion of the modified second construction module data related to the first construction module and update the first construction module data with the portion of the modified second construction module data related to the first construction module.

It should be understood that the foregoing description is only illustrative of the invention. Various alternatives and modifications can be devised by those skilled in the art without departing from the invention. Accordingly, the present invention is intended to embrace all such alternatives, modifications and variances.

What is claimed is:

1. A building material and workflow control system adapted to manage workflow associated with building of a construction project at job site, the building material and workflow control system comprising:
a server having a processor and a database;
the processor programmed to identify a construction sequence of the construction project;
the processor further programmed to identify kits of assets and materials associated with respective portions of the construction sequence; and
the processor further programmed to identify and generate assembly features on the materials related to assets characteristics in the respective portion of the construction sequence;
wherein, the processor is further programmed to provide and stage the kits of assets and materials from a source to the jobsite utilizing real time dynamic knowledge of an erection state of the building at the job site.

2. The building material and workflow control system of claim 1 wherein the assets comprise human resources and construction equipment.

3. The building material and workflow control system of claim 1 wherein the assets comprise human assisted construction automation.

4. The building material and workflow control system of claim 1 wherein the materials comprise lumber and fasteners.

5. The building material and workflow control system of claim 1 wherein the materials comprise prefabricated panels.

6. The building material and workflow control system of claim 1 wherein the real time dynamic knowledge of the erection state of the building at the job site arises from communication between a position sensing device on the assets or materials and the server.

7. The building material and workflow control system of claim 1 wherein the real time dynamic knowledge of the erection state of the building at the job site arises from communication between human resources at the job site and the server.

8. The building material and workflow control system of claim 1 wherein server updates the erection state of the building at the job site based on real time feedback from the assets.

9. The building material and workflow control system of claim 1 wherein the kits of assets and materials are identified to ensure construction code compliance.

10. The building material and workflow control system of claim 1 wherein the kits of assets and materials are updated to accommodate a detected variance from a design condition.

11. The building material and workflow control system of claim 1 wherein the construction project comprises a residential home building construction project.

12. The building material and workflow control system of claim 1 wherein the erection state includes a kitting and manufacturing state of the materials.

13. A building material and workflow control system adapted to manage items and workflow information associated with building of a construction project at a job site, the building material and workflow control system comprising:
a processor programmed to maintain a database having temporal data associated with real time dynamic knowledge of the items and the workflow;
the temporal data including a dynamic erection state during different phases of erection of the construction project; and
the processor having a communication interface communicably connecting the processor to the job site, the communication interface being configured for bi-directional communication between processor and job site, wherein, the erection state is registered by the processor from bi-directional communication between the database and assets utilized at the job site.

14. The building material and workflow control system of claim 13, wherein the communication comprises a status of different process steps at the job site.

15. The building material and workflow control system of claim 13, wherein the communication comprises a status of different assets at the job site.

16. The building material and workflow control system of claim 13, wherein the communication comprises a location of the assets at the job site.

17. The building material and workflow control system of claim 13, wherein the communication comprises a location of building materials at the job site.

18. The building material and workflow control system of claim 13, wherein the communication comprises communication between a position sensing device on the assets or materials and the server.

19. The building material and workflow control system of claim 13 wherein the construction project comprises a residential home building construction project.

20. The building material and workflow control system of claim 13 wherein the erection state includes a kitting and manufacturing state of building materials.

21. A construction control system adapted to manage items and workflow associated with building of a construction project, the construction control system comprising:
a processor with a database having real time dynamic knowledge of the items; and
the real time dynamic knowledge of items including a state of construction of the items and a location of the items from initialization of the item into the construction project to final employment of the item in the construction project.

22. The construction control system of claim 21 wherein the database is updated to accommodate a detected variance from a design condition.

23. The construction control system of claim 21 wherein the database is updated to accommodate a detected variance between a planned state of construction and an actual state of construction.

24. The construction control system of claim 21 wherein the database identifies and sequences kits associated with the items.

25. The construction control system of claim 21 wherein the location is determined by communication between a location sensor on one or more of the items and the database.

26. The construction control system of claim 21 wherein the items comprise construction assets and building materials.

27. The construction control system of claim 21 wherein the items comprise human assisted construction automation.

28. The construction control system of claim 21 wherein the construction project comprises a residential home building construction project.

29. The construction control system of claim 21 wherein the state of construction includes a kitting and manufacturing state of the items.

30. A construction control system adapted to manage items and workflow associated with building of a construction project, the construction control system comprising:
a processor with a database having real time dynamic knowledge of the items; and
the real time dynamic knowledge of the items including information and data in the database identifying at least one predetermined characteristic of an item based on both a design condition and a variance from the design condition;
wherein, the at least one predetermined characteristic of the item includes information related to a variance relative to the design condition.

31. The construction control system of claim 30 wherein the database is updated to accommodate the variance from the design condition.

32. The construction control system of claim 30 wherein the database is updated to accommodate the variance detected during construction, the variance being between a planned state of construction and an actual state of construction.

33. The construction control system of claim 30 wherein the database identifies and sequences kits associated with the items.

34. The construction control system of claim 30 wherein the variance is determined by communication between a location sensor on one or more of the items and the database.

35. The construction control system of claim 30 wherein the items comprise construction assets and building materials.

36. The construction control system of claim 30 wherein the items comprise human assisted construction automation.

37. The construction control system of claim 30 wherein the construction project comprises a residential home building construction project.

38. The construction control system of claim 30 wherein the real time dynamic knowledge includes knowledge associated with a kitting and manufacturing state of building materials.

39. A construction control system adapted to interface between first and second construction modules and adapted to manage data associated with building of a construction project, construction control system comprising:
a server having a processor and a database;
the server adapted to extract second construction module data related to the second construction module from first construction module data related to the first construction module;
wherein, the server is adapted to modify the second module data as modified second construction module data, and wherein the server is adapted to extract a portion of the modified second construction module data related to the first construction module and update the first construction module data with the portion of the modified second construction module data related to the first construction module.

40. The construction control system of claim 39 wherein the first and second construction modules comprise different construction design modules.

41. The construction control system of claim 39 wherein the first construction module comprises a scheduling module and wherein the second construction module comprises a design module.

42. The construction control system of claim 39 wherein the construction project comprises a residential home building construction project.

43. The construction control system of claim 39 wherein the data associated with the building of the construction project is updated in real time by the server.
